(19) United States
(12) Patent Application Publication
(10) Pub. No.: US 2006/0060553 A1
(43) Pub. Date: Mar. 23, 2006

(54) Baby bottle cap holder

(76) Inventor: Larry Lee Fleming, Atco, NJ (US)

Correspondence Address: Larry Fleming, 137 Lakeside Drive, Atco, NJ, 08004, US

(21) Appl. No.: 10/856,072

(22) Filed: Sep. 23, 2004

(51) Int. Cl. A61J 9/04

(52) U.S. Cl. 215/11.6

(57) ABSTRACT

This invention is a baby bottle cap holder, that stores the cap that covers the nipple, on the bottle. The cap is removed from the top of the bottle to the bottom of the bottle for storage. This cap snaps into the circumference of the outside wall at the bottom of the bottle, that stores the cap when time time to feed. The cap can be any size, shape, or color. It can also be attached by snap fit into a slot, or snug fitted, or threaded on. This keeps the nipple clean at all times. It's always within hands reach, not lost under a bed or dresser. The cap gathers dust when on the floor, or family pets can get in their mouths. When traveling it's easier to keep track of the cap, with the cap storage on the bottle.

### BACKGROUND OF THE INVENTION

### 1) Field of Invention

This invention is a baby bottle cap holder. The cap covers the nipple. Transfer the cap from the top of the bottle to the bottom of the bottle. The cap snaps on the bottom of the bottle for storing the cap. The biggest problem parents have with the baby bottle cap, is when removing the cap from the top of the baby bottle; they lay the cap down and then have to search for the baby bottle cap finding it several hours later, if ever. The cap falls to the floor and rolls under furniture or you sit if down and someone moves it. Pets play with the caps, dust gets in the caps. When you can't locate the cap and leave the baby bottle unattended pets can lick the nipple. If you store the baby bottle in a diaper bag without a cap, the nipple gathers dust. If you drop the baby bottle without a cap, you then have to wash the nipple off. We can see keeping the nipple covered by the cap prevents germs. These are some of the problems parents face when they are unable to locate the baby bottle cap. Again, these are a few of the reasons why this addition is needed to a baby bottle cap.

### BRIEF DESCRIPTION OF THE DRAWINGS:

FIG. 1) This is a view of a baby bottle with cap, that snaps on over the nipple, that can be removed from the top of the bottle and snapped on to the bottom of the bottle.

FIG. 2) Shows the cap on the top of the bottle, covering the nipple. The bottom of the bottle shows where the cap snaps on, has a slightly beveled rim inside the bottom of the cap. The entire circumference of the bottom of the cap is slightly beveled for easy snap on fit.

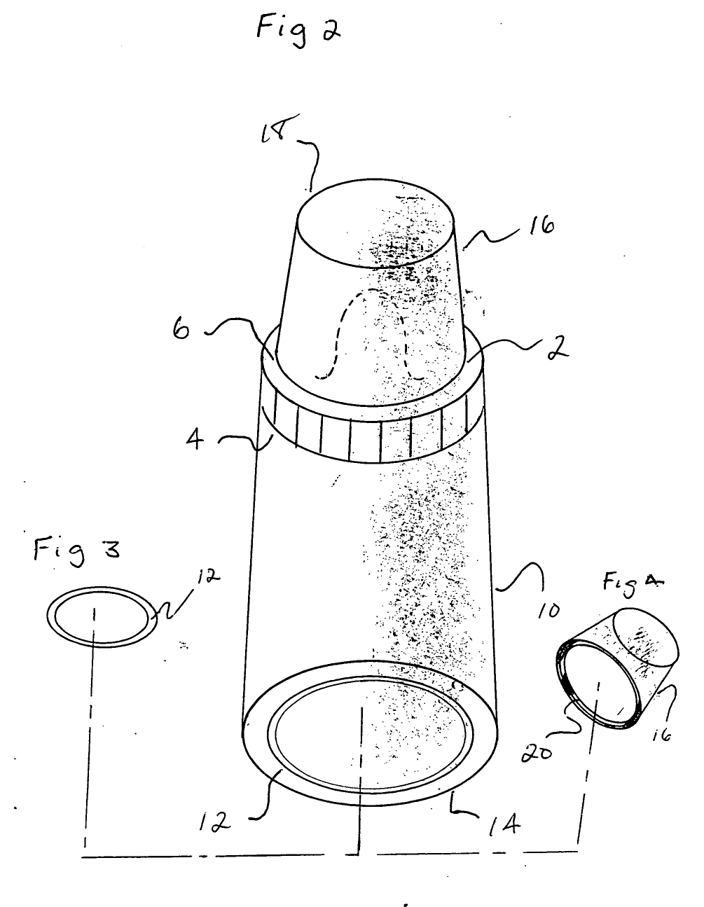

FIG. 3) The center line indicates the cap snaps on to the beveled bottom of the bottle, with a snug fit.

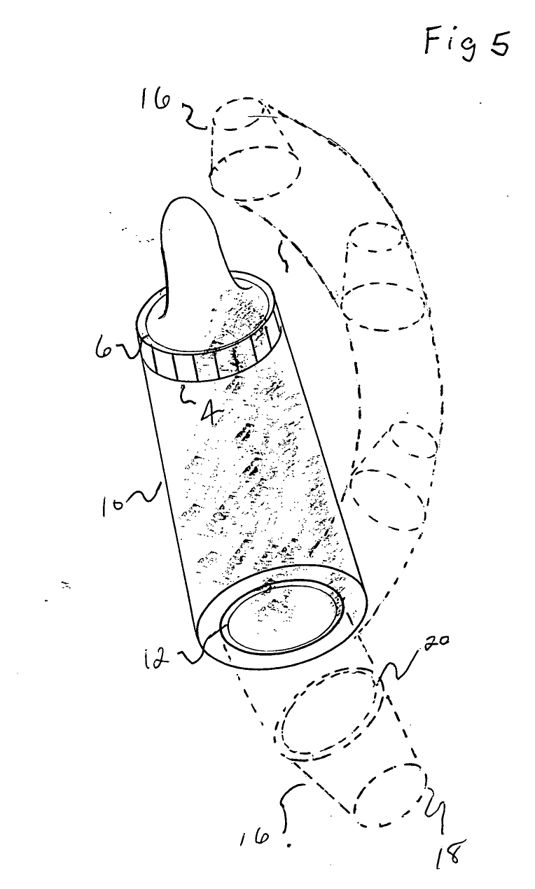

FIG. ) The center line indicates that the cap snaps on the beveled bottom of the bottle, to hold the bottle cap on the bottle.

FIG. ) This view is showing that the bottle cap is removed from the top of the bottle and snapped at the bottom of the baby bottle with a snug fit. The dotted line displays how the cap is attached and detached, from the top of the bottle to the bottom of the bottle.

### DETAILED DESCRIPTION OF THE PREFERRED EMBODIMENT

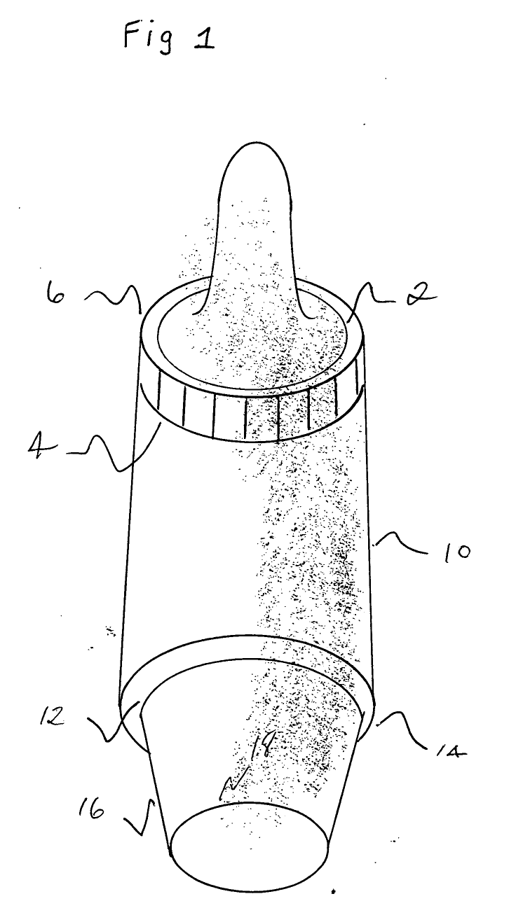

As depicted in FIGS. 1 thru , this particular invention pertains to a baby bottle cap 16 which snaps on to the top of the baby bottle 12 this cap can also be attached by snap fitting, threaded, velcro, magnetic suction fitting. The cap may have a variety of shapes 16 colors and sizes. The bottom of the bottle 1 is beveled the entire diameter of the bottom of the bottle is beveled 12 in order for the cap to snap on the bottom of the bottle 2 this will keep the cap from getting lost just simply remove the bottle cap from the top of the bottle before feeding 1 transfer to the bottom of the bottle for snap fit 20 this cap will be manufactured at complimenting measurements to be sure all parts fit exact This is a great addition to the already existing baby bottle cap, to have a snap fit on the bottom.

I claim:

1. This invention is for storage for a baby bottle cap The cap is removed from the top of the bottle that covers the nipple and is transferred to the outside wall of the bottom of the bottle for storage The cap can be any size, shape, or color It can also be attached by snap fit into a slot, or snug fitted, threaded on, or secured with velcro This insures the nipple will always be within hands reach, thereby keeping the nipple clean. It will not be lost under a bed, or dresser on the floor gathering dust, or on the floor where family pets can get the cap in their mouths. Whether at home or traveling this makes it much easier to keep track of the cap, with the cap storage on the bottle.
